(19) United States
(12) Patent Application Publication
(10) Pub. No.: US 2005/0237903 A1
(43) Pub. Date: Oct. 27, 2005

(54) Optical pickup head compatible with two different optical recording media

(75) Inventor: Wen-Hsin Sun, Tucheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/077,782

(22) Filed: Mar. 11, 2005

(30) Foreign Application Priority Data
Apr. 23, 2004 (TW) 93111389

(51) Int. Cl. G11B 7/00

(52) U.S. Cl. 369/112.21

(57) ABSTRACT

An optical pickup head compatible with two different optical recording media includes a first semiconductor module emitting a first light beam with a first wavelength; a second semiconductor module emitting a second light beam with a second wavelength greater than the first wavelength; a prism module including a reflective multi-surface prism for changing a transmission direction of a light beam passing therethrough by reflecting the light beam between surfaces thereof, an optical path coupler disposed between the first and second semiconductor modules and the reflective multi-surface prism for coupling the first and second light beams and transmitting the first and second light beams toward the reflective multi-surface prism, and an aspherical surface for converging the second light beam; and an objective lens for receiving the first and second light beams and transmitting the first and second light beams to two different recording media respectively.

### BACKGROUND OF THE INVENTION

1. Field of the Invention

The present invention generally relates to an optical pickup head compatible with two different optical recording media.

2. Prior Art

An optical pickup head carries out recording and/or reproducing of information such as video, audio or other data from a recording medium. In such system, a semiconductor laser is used for generating a light beam, and an objective lens is used for converging the light beam and forming a focused spot on the recording medium. The recording density of the recording medium is determined by the size of the focused spot. In general, the size of the focused spot (S) is proportional to the wavelength (λ) of the light beam, and inversely proportional to the numerical aperture (NA) of the objective lens, as expressed by formula (1):
S∝λ/NA (1)

Therefore, to increase the recording density, the size of the spot being focused on the optical disk must be reduced. To reduce the spot size, as can be inferred from formula (1), the wavelength (λ) of the light beam must be reduced and/or the numerical aperture (NA) of the objective lens must be increased. This has been demonstrated by the ongoing development of optical recording media. For example, the wavelength of read beams for compact disks (CDs) is about 780 nm, the wavelength of read beams for digital versatile disks (DVDs) is about 650 nm, and the wavelength of read beams for high-definition DVDs (HD-DVDs) is about 405 nm. Furthermore, the numerical aperture for CDs is 0.45, the numerical aperture for DVDs is 0.6, and the numerical aperture for HD-DVDs is 0.65-0.8.

On the other hand, coma aberration, which occurs due to tilting of the optical disk, is associated with a tilt angle of the disk, a refractive index of a disk substrate, a thickness of the disk substrate, and a numerical aperture of the objective lens. To ensure an acceptable level of coma aberration with respect to tilting of a disk for high-density recording, the thickness of the disk substrate is in general reduced accordingly. For example, CDs have a thickness of 1.2 mm, and DVDs have a thickness of 0.6 mm. Further, the thickness of many HD-DVDs is 0.6 mm or less.

In an apparatus for high-density recording onto or playing from a medium such as an HD-DVD, a primary consideration is the compatibility of the apparatus with existing disks including CDs and DVDs. Conventionally, there are two kinds of optical writing and/or reading systems that are used in multi-compatible home entertainment players. In the first kind of optical writing and/or reading system, an independent optical system is provided therein for each type of disk. That is, generally, the optical writing and/or reading system has at least two light sources and two objective lenses for two disks. This kind of writing and/or reading system needs too many optical elements, and is unduly large and costly. In the second kind of writing and/or reading system, there are some common optical elements, for example, a common objective lens. This kind of writing and/or reading system is disclosed in U.S. Pat. No. 6,324,150. This kind of writing and/or reading system reduces the total number of optical elements and simplifies the overall configuration. However, the optical performance of the optical pickup head is limited. In respect of the common objective lens, chromatic aberration occurs because each kind of disk operates according to different wavelengths. Further, spherical aberration occurs because the disks have different thicknesses.

### SUMMARY OF THE INVENTION

Accordingly, an object of the present invention is to provide a minimal-sized optical pickup head compatible with two different optical recording media, in which optical aberrations are corrected.

To achieve the above object, an optical pickup head for optical recording media in accordance with the present invention comprises: a first semiconductor module emitting a first light beam with a first wavelength; a second semiconductor module emitting a second light beam with a second wavelength greater than the first wavelength; a prism module including a reflective multi-surface prism for changing a transmission direction of a light beam passing therethrough by reflecting the light beam between surfaces thereof, an optical path coupler disposed between the first and second semiconductor modules and the reflective multi-surface prism for coupling the first and second light beams and transmitting the first and second light beams toward the reflective multi-surface prism, and an aspherical surface for converging the second light beam; and an objective lens for receiving the first and second light beams and transmitting the first and second light beams to two different recording media respectively.

### BRIEF DESCRIPTION OF THE DRAWINGS

Other objects, advantages and novel features of the present invention will be drawn from the following detailed description of preferred embodiments of the present invention with the attached drawings, in which:

FIG. 1 is an isometric view of an arrangement of an optical pickup head according to a first embodiment of the present invention, also showing essential optical paths thereof;

FIG. 2 is a top view of a prism module of the optical pickup head of the first embodiment of the present invention, also showing essential optical paths thereof; and

FIG. 3 is an isometric view of an arrangement of an optical pickup head according to a second embodiment of the present invention, also showing essential optical paths thereof.

### DETAILED DESCRIPTION OF THE INVENTION

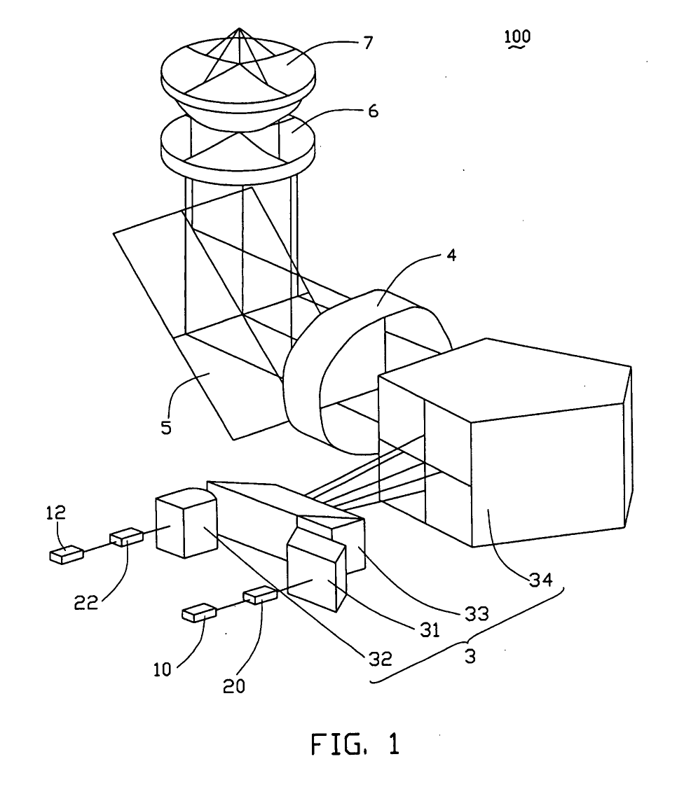

Referring to FIG. 1, an optical pickup head 100 for optical recording media according to a first embodiment of the present invention is illustrated. The optical pickup head 100 is used in an information recording and/or reproducing device (not shown) compatible with a first optical disk (not shown) having a higher recording density and a second optical disk (not shown) having a lower recording density. The optical pickup head 100 comprises a first and second semiconductor modules 10, 20 for emitting a first and second light beams and receiving a first and second return light beams, a first and second holographic lenses 20, 22 for directly propagating a light beam therethrough from one side thereof and deflecting a light beam therethrough from the other side thereof, a prism module 3, a collimating lens 4, an optical path changer 5, a wavelength selector 6, and an objective lens 25. The first and second semiconductor modules 11, 12, and the first and second holographic lenses 20, 22 are respectively juxtaposed with each other.

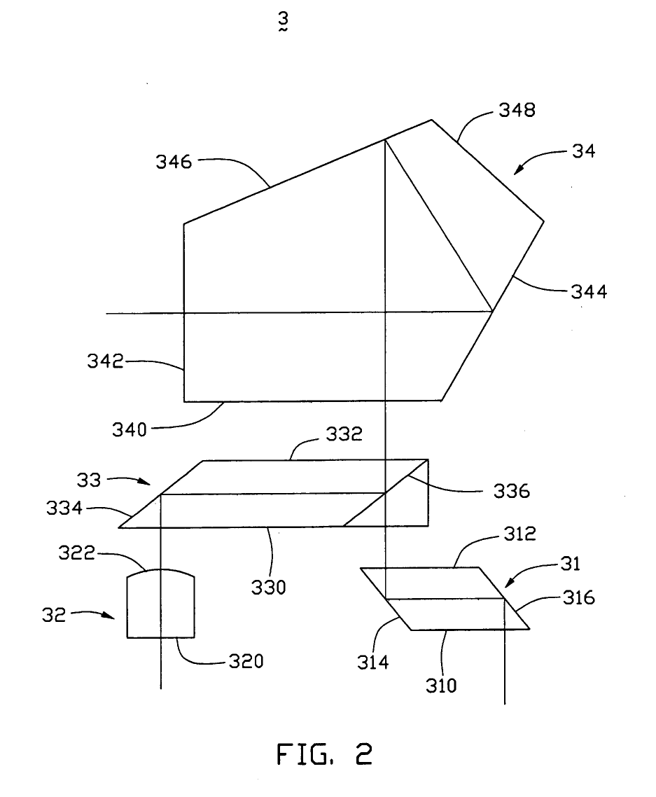

Also referring to FIG. 2, the prism module 3 comprises four prisms 31, 32, 33 and 34. The first and second prisms 31 and 32 are juxtaposed on a same side of the third prism 33, and respectively face the first and second semiconductor modules 11 and 12. The first holographic lens 20 is disposed on an optical path between the first semiconductor module 10 and the first prism 31, and the second holographic lens 22 is disposed on an optical path between the second semiconductor module 12 and the second prism 32. The fourth prism 34 is positioned on an opposite side of the third prism 33. The collimating lens 4 is positioned on another side of the fourth prism 34, and accords with the wavelength of the first light beam so as to converge the first light beam into a parallel light beam. The optical path changer 5 is aslant so as to reflect a light beam from the collimating lens 4 to the wavelength selector 6. The objective lens 7 has a numerical aperture specified by the first optical disk, which is larger than a numerical aperture specified by the second optical disk. The wavelength selector 6 is located beside the objective lens 7, to selectively transmit a light beam thereto.

The first prism 31 is parallelepiped, and includes a first incident surface 310, a first emergent surface 312 parallel to the first incident surface 310, and two parallel first reflective surfaces 314 and 314 interconnecting the first incident surface 310 and first emergent surface 312. The second prism 32 is formed with an aspherical surface, and includes a second incident surface 320 and a second emergent surface 322. In the illustrated embodiment, the aspherical surface is provided at the second emergent surface 321. In alternative embodiments, the aspherical surface can be provided at the second incident surface 320 or on the third prism 33. The third prism 33 as an optical path coupler comprises a third incident surface 330, a third emergent surface 332 parallel to the third incident surface 330, a third reflective surface 334 interconnecting the third incident surface 330 and the third emergent surface 332 at corresponding ends thereof, and an optical path synthesizing/separating surface 336 parallel to the third reflective surface 334 at an opposite side of the third prism 33. Parts of the first emergent surface 312 and the second emergent surface 322 are juxtaposed beside two opposite ends of the third incident surface 330 respectively. A light beam from the first semiconductor module 10 propagates from the optical path synthesizing/separating surface 336 toward a fourth incident surface 340 of the fourth prism 34, and a light beam from the second semiconductor module 12 is reflected by the optical path synthesizing/separating surface 336 and transmits toward the fourth incident surface 340 of the fourth prism 34.

The fourth prism 34, the collimating lens 4, the optical path changer 5, the wavelength selector 6 and the objective lens 7 are sequentially arranged in a common optical path. The fourth prism 34 is a pentagonal prism, and comprises a fourth incident surface 340, a fourth emergent surface 342, and three fourth reflective surfaces 344, 346 and 348 interconnecting the perpendicular fourth incident surface 340 and the fourth emergent surface 342. The optical path changer 5 can be a mirror. The wavelength selector 6 has different transmissivities according to the different wavelengths.

In the present embodiment, the first optical disk may be a future generation digital versatile disk which has a great numerical aperture and corresponds to a short wavelength, for example, an HD-DVD. The second optical disk may be a DVD, which has a small numerical aperture and corresponds to a long wavelength. The first light beam is used for recording an information signal on and/or reproducing an information signal from the first optical disk. The light beam generated by the first semiconductor module 10 has a relatively short wavelength of about 405 nm, which is suitable for the first optical disk. The light beam generated by the second light source 12 has a relatively long wavelength of about 650 nm, which is suitable for the second optical disk. Further, both the collimating lens 4 and the objective lens 7 have optical parameters according with the short wavelength for the first optical disk, and the objective lens 7 also has a great numerical aperture according with the first optical disk.

When recording an information signal on and/or reproducing an information signal from the first optical disk, the first semiconductor module 10 emits a first light beam having the short wavelength of about 405 nm. Then, after passing through the first holographic lens 20 along the original direction thereof, the first light beam enters the first prism 31 through the first incident surface 310. In the first prism 31, the first light beam is reflected by the two opposite first reflective surfaces 314 and 316, and is then output from the first emergent surface 312. The first light beam transmits into the third prism 33 through the third incident surface 330, and propagates to the optical path synthesizing/separating surface 336. The first light beam passes through the optical path synthesizing/separating surface 336 along its original direction, because of its short wavelength. Subsequently, the first light beam transmits out from the third emergent surface 331.

After exiting the third prism 33, the first light beam transmits into the fourth prism 34 through the fourth incident surface 340, and propagates to the fourth emergent surface 342 after being reflected by the fourth reflective surfaces 344 and 346. The first light beam is condensed by the collimating lens 4 and transformed into a parallel light beam of a first luminous flux. Because the collimating lens 4 accords with the wavelength of the first light beam, it can enable beams of the first luminous flux to be fully parallel to each other. The first luminous flux transmits to the optical path changer 5, which changes a transmission direction toward the first optical disk. Accordingly, the first luminous flux illuminates the wavelength selector 6. The wavelength selector 6 does not block the first luminous flux, so that the first luminous flux completely passes through the wavelength selector 6 and is incident on the objective lens 7. The objective lens 7 converges the first luminous flux to form a focused light spot (not shown) on the first optical disk.

After forming the light spot on the first optical disk, the first optical disk reflects the incident beam as a first return beam (not labeled). The first return beam sequentially passes through/from the objective lens 7, the wavelength selector 6, the optical path changer 5, the collimating lens 4, and the prism unit 3, and reaches the first holographic lens 20. The first holographic lens 20 diffracts the first return beam toward the first semiconductor module 10. Then, the first semiconductor module 10 receives the first return beam and generates corresponding electrical signals.

When recording an information signal on and/or reproducing an information signal from the second optical disk, the second semiconductor module 12 emits a second light beam (not labeled) with the long wavelength of about 650 nm. The second light beam passes through the second holographic lens 22 along its original direction, and enters the second prism 32 through the second incident surface 320. The second light beam propagates to the second emergent surface 322 of the second prism 32, and is converged first by the aspherical surface of the second emergent surface 322. The converged second light beam transmits into the third prism 33 through the third incident surface 330, is reflected by the third reflective surface 332, and propagates to the optical path synthesizing/separating surface 336. The optical path synthesizing/separating surface 336 reflects the second light beam because of its long wavelength. Subsequently, the second light beam passes through the third emergent surface 330.

After exiting the third prism 33, the first light beam transmits into the fourth prism 34 through the third incident surface 340, and passes through the fourth emergent surface 342 after being reflected by the fourth reflective surfaces 344 and 346. The second light beam is condensed by the collimating lens 4 and transformed into a parallel light beam of a second luminous flux. The second luminous flux transmits to the optical path changer 5, which changes a transmission direction toward the second optical disk. Accordingly, the second luminous flux illuminates the wavelength selector 6. The wavelength selector 6 blocks a peripheral part of the second luminous flux, so that a central part of the second luminous flux passes through the wavelength selector 6 and is incident on the objective lens 7. The objective lens 7 converges the second luminous flux to form a focused light spot (not shown) on the second optical disk.

After forming the light spot on the second optical disk, the second optical disk reflects the incident beams as a second return beam (not labeled). The second return beam sequentially passes through/from the objective lens 7, the wavelength selector 6, the optical path changer 5, the collimating lens 4, and the prism unit 3, and reaches the second holographic lens 22. The second holographic lens 22 diffracts the second return beam toward the second semiconductor module 12. Then, the second semiconductor module 12 receives the second return beam and generates corresponding electrical signals.

In the above-mentioned optical pickup head 100, both (i) the working wavelength of optical elements, such as the first semiconductor module 10, the collimating lens 4 and the objective lens 7, and (ii) the numerical aperture of the objective lens 7, are directly matched with requirements of the first optical disk. Therefore, when recording an information signal on and/or reproducing an information signal from the first optical disk, the optical pickup head 100 provides high quality light convergence to the focused light spot. Further, because the aspherical surface is formed on the second prism 32, aberrations caused by non-matching between the second luminous flux and the collimating lens 4 and objective lens 7 are corrected. Moreover, the wavelength selector 6 selects a part of the light beam with long wavelength transmitting to the objective lens 7, so that only a central part of the objective lens 7 is illuminated by the second light beam. Thus the NA of the objective lens 7 is reduced when focusing the second light beam, and corresponds to the small NA required by the second optical disk. Hence, when recording an information signal on and/or reproducing an information signal from the second optical disk, the optical pickup head 100 provides high quality light convergence to the focused light spot.

Furthermore, because the first and second light beams are reflected between the surfaces of the prism unit 3, the distance between the collimating lens 4 and the first and second semiconductor modules 11 and 12 is reduced. This enables the optical pickup head 100 to be miniaturized. Moreover, the aspherical surface is directly formed on the second prism 32, so that no extra optical element need be added to the optical pickup head 100. This further facilitates miniaturization of the optical pickup head 100, and improves the efficiency of mass production.

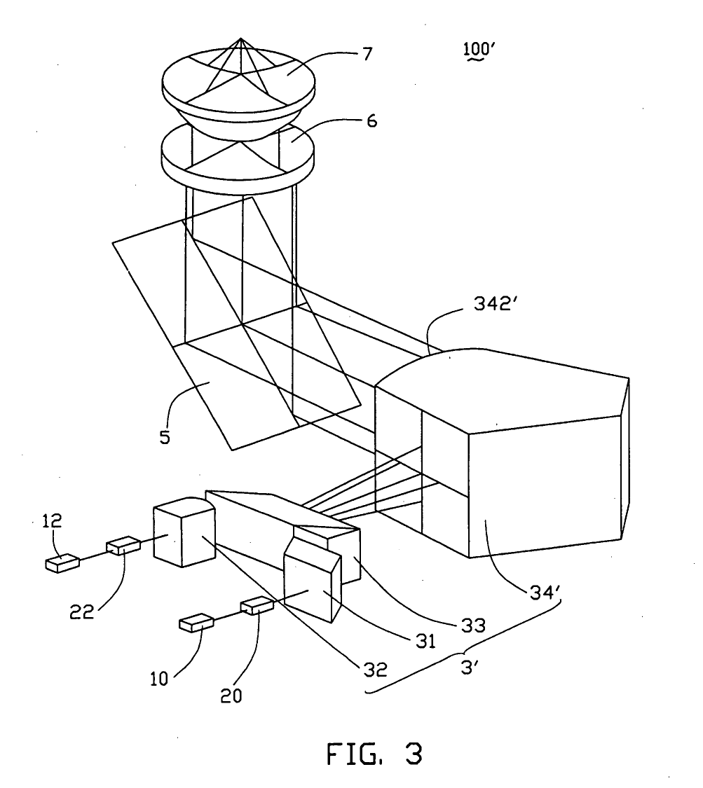

Referring to FIG. 3, an optical pickup head 100′ compatible with recording media according to a second embodiment of the present invention is illustrated. Unlike in the optical pickup head 100 of the first embodiment, the optical pickup head 100′ includes a fourth prism 34′ integrating a pentagonal prism and a collimating lens. A collimating surface 342′ is formed on an emergent surface of the fourth prism 34′ which faces the optical path changer 5. Thereby, the optical pickup head 100′ has a further simplified configuration.

Although the present invention has been described with reference to specific embodiments, it should be noted that the described embodiments are not necessarily exclusive, and that various changes and modifications may be made to the described embodiments without departing from the scope of the invention as defined by the appended claims.

1. An optical pickup head compatible with two different optical recording media, comprising:
a first semiconductor module emitting a first light beam with a first wavelength;
a second semiconductor module emitting a second light beam with a second wavelength greater than the first wavelength;
a prism module including a reflective multi-surface prism for changing a transmission direction of a light beam passing therethrough by reflecting the light beam between surfaces thereof, an optical path coupler disposed between the first and second semiconductor modules and the reflective multi-surface prism for coupling the first and second light beams and transmitting the first and second light beams toward the reflective multi-surface prism, and an aspherical surface for converging the second light beam; and
an objective lens for receiving the first and second light beams and transmitting the first and second light beams to two different recording media respectively.

2. The optical pickup head according to claim 1, wherein the prism module further comprises an aspherical surface for the second light beam to pass therethrough.

3. The optical pickup head according to claim 2, wherein the aspherical surface is formed on the second prism.

4. The optical pickup head according to claim 3, wherein the first and second prisms are disposed on a same side of the optical path coupler and juxtaposed with each other.

5. The optical pickup head according to claim 4, wherein the optical path coupler comprises a first portion facing the first semiconductor module, a second portion facing the second semiconductor module, and an interface interconnecting the first and second portions.

6. The optical pickup head according to claim 5, wherein the first light beam passes through the interface along its original direction, and the second light beam is reflected by the interface.

7. The optical pickup head according to claim 2, wherein an incident surface and an emergent surface of the reflective multi-surface prism are perpendicular to each other.

8. The optical pickup head according to claim 7, wherein the reflective multi-surface prism is a pentagonal prism.

9. The optical pickup head according to claim 8, further comprising a collimating lens disposed between the pentagonal prism and the objective lens.

10. The optical pickup head according to claim 9, further comprising a wavelength selector between the collimating lens and the objective lens; wherein the wavelength selector does not block the first light beam and blocks a peripheral part of the second light beam.

11. The optical pickup head according to claim 7, wherein the emergent surface of the reflective multi-surface prism is a collimating surface.

12. The optical pickup head according to claim 11, further comprising a wavelength selector between the fourth prism and the objective lens; wherein the wavelength selector does not block the first light beam and blocks a peripheral part of the second light beam.

13. An optical pickup head compatible with two different optical recording media, comprising:
a first semiconductor module emitting a first light beam with a first wavelength;
a second semiconductor module emitting a second light beam with a second wavelength greater than the first wavelength;
a prism module including a reflective multi-surface prism for changing a transmission direction of a light beam passing therethrough by reflecting the light beam between surfaces thereof, an optical path coupler disposed between the first and second semiconductor modules and the reflective multi-surface prism for coupling the first and second light beams and transmitting the first and second light beams toward the reflective multi-surface prism, and an aspherical surface for converging the second light beam;
a collimating lens disposed beside the prism module for collimating the incident first and second light beams; and
an objective lens for receiving the first and second light beams and transmitting the first and second light beams to two different recording media respectively.

14. The optical pickup head according to claim 13, wherein an incident surface and an emergent surface of the reflective multi-surface prism are perpendicular to each other.

15. The optical pickup head according to claim 14, wherein the reflective multi-surface prism is a pentagonal prism.

16. The optical pickup head according to claim 15, wherein the reflective multi-surface prism and the collimating lens are integrally formed with a collimating surface facing the optical path changer.

17. The optical pickup head according to claim 13, wherein the optical path coupler comprises an aspherical surface for the second light beam to pass therethrough.

18. An information recording and/or reproducing device compatible with at least two different optical recording media, said device having an optical pickup head to obtain information from a selective one of said at least two different optical recording media, said optical pickup head further comprising:
a first semiconductor module emitting a first light beam with a first wavelength;
a second semiconductor module emitting a second light beam with a second wavelength greater than the first wavelength;
a prism module facing said first and second semiconductor modules for receiving said first and second light beams therefrom respectively, said prism module having a reflective multi-surface prism for receiving said first and second light beams and reflecting said received first and second light beams therein at least two times to change a transmission direction thereof, and an aspherical surface disposed to exclusively allow passage of said second light beam in said prism module; and
an objective lens disposed next to said selective one of said at least two different optical recording media for receiving said first and second light beams from said prism module and transmitting said first and second light beams to said selective one of said at least two different optical recording media.

19. The information recording and/or reproducing device according to claim 18, wherein said prism module has a first prism facing said first semiconductor module to receive said first light beam and a second prism facing said second semiconductor module to receive said second light beam.

20. The information recording and/or reproducing device according to claim 19, wherein said aspherical surface is formed on said second prism.
